(19) United States
(12) Patent Application Publication
(10) Pub. No.: US 2008/0243593 A1
(43) Pub. Date: Oct. 2, 2008

(54) SYSTEM AND METHOD FOR DISPLAYING VARIABLE ADVERTISING CONTENT

(75) Inventors: Kyung Sun Ko, Seoul (KR); Minuk Kim, Seoul (KR)

Correspondence Address: HUSCH BLACKWELL SANDERS LLP, 720 OLIVE STREET, SUITE 2400, ST. LOUIS, MO, 63101, US

(73) Assignee: NHN CORPORATION, Kyunggi-do (KR)

(21) Appl. No.: 12/055,391

(22) Filed: Mar. 26, 2008

(30) Foreign Application Priority Data
Mar. 29, 2007 (KR) 10-2007-0031024

(51) Int. Cl. G06Q 30/00; G06F 7/06; G06F 17/30

(52) U.S. Cl. 705/10; 705/14; 707/3; 707/104.1; 707/E17.014

(57) ABSTRACT

A method for providing advertising content received from an advertiser comprises: receiving at least one advertising content associated with at least one target user group, and at least one search keyword associated with the at least one advertising content from an advertiser; associating the at least one target user group with at least one demographic category of users; storing the at least one advertising content in association with the at least one demographic category and the at least one search keyword in an advertisement database; detecting a search request from a user; obtaining user profile information associated with the user; retrieving advertising content from the advertisement database corresponding to demographic information contained in the obtained user profile information and the at least one search keyword received from the user; and displaying at least a portion of the retrieved advertising content to the user. The advertising contents include at least one search keyword and brief description, such as a title and/or description of the advertised subject matter.

### CROSS-REFERENCE TO RELATED APPLICATION

This application claims the benefit of Korean Patent Application No. 10-2007-0031024, filed on Mar. 29, 2007, in the Korean Intellectual Property Office, the disclosure of which is incorporated herein by reference.

### BACKGROUND OF THE INVENTION

1. Field of the Invention

The present invention relates to the field of online advertising in general, and in particular to a method and system for providing variable advertising content targeted to specific users based on search keywords and user profiles.

2. Description of Related Art

Generally, the Internet is used when users desire to obtain information. When the user enters a query word or search keyword, the Internet provides information according to the query word along with advertisement data associated with the query word. Accordingly, it is possible to improve the advertising effect by providing targeted advertisements directed to specific user groups. Due to the above advantages, Internet advertisement is popular among advertisers as an optimal spot for displaying advertisement data.

One Internet advertisement according to a conventional art displays a plurality of advertisement data in an advertisement region of a web page through rolling. For this, a search service providing system enables an advertiser to register in advance an advertisement to be displayed in a particular advertisement region in a particular point in time. At the particular point in time, the search service providing system displays the registered advertisement in the particular advertisement region. Also, another Internet advertisement enables the advertiser to register a particular search word associated with advertisement. When a user enters the particular search word, the search service providing system displays a search result and the advertisement that is registered in association with the particular search word.

However, since the conventional advertisement schemes randomly display a plurality of advertisements in a limited advertisement region, it is difficult to attract a search service user's attention to a displayed advertisement. Accordingly, unsatisfactory advertising effects may be obtained. Also, only an advertisement associated with a particular search word is displayed. Specifically, due to the limited advertisement region and a restricted keyword selection, it is difficult to expand the advertisement market.

Accordingly, in order to solve the above-described problems, there is a need for a method that can enable an advertiser to register a plurality of advertisement data and can verify an advertisement target associated with each of the advertisement data and appropriately display the advertisement data according to the advertisement target.

### BRIEF SUMMARY OF THE INVENTION

Each of advertising content generally comprises three parts: (1) title of the advertisement, (2) brief description of the advertisement, and (3) a link to a Web page containing the subject matter of the advertisement. An aspect of the present invention provides a method and system for providing variable advertising content received from an advertiser. The system and method of the present invention provide customized title and brief description of the advertisement to users based, at least in part, upon search keyword and the user profile information so as to entice the users to the displayed advertisement. The advertising contents are directed to users based, at least in part, upon search keywords and user profile information. The method of the present invention comprises: receiving at least one advertising content associated with at least one target user group, and at least one search keyword associated with the at least one advertising content from an advertiser; associating the at least one target user group with at least one demographic category of potential users; associating the at least one advertising content with the at least one demographic category and the at least one search keyword in an advertisement database; detecting a search request from a user; obtaining user profile information associated with the user; retrieving advertising content from the advertisement database corresponding to demographic information contained in the obtained user profile information and the at least one search keyword received from the user; and displaying at least a portion of the retrieved advertising content to the user. The advertising content includes brief description of an advertisement. The search request includes at least one search keyword.

Another aspect of the present invention also provides a method and system for receiving from the advertiser the advertising content and a plurality of search keywords; and indexing the advertising content based, at least in part, upon similarity of the search keywords.

Another aspect of the present invention also provides a method and system for receiving from the advertiser the advertising content and a plurality of search keywords; and indexing the advertising content based, at least in part, upon similarity of the search keywords.

Another aspect of the present invention also provides a method and system for receiving from the advertiser a link to a targeted web page associated with advertising content; storing the advertising content in association with the received link; and providing the link to the targeted web page associated with advertising content in response to the search request.

According to another aspect of the present invention, there is provided a system for providing advertising content. The system comprises: an information receiving module configured to receive at least one advertising content associated with at least one target user group, and at least one search keyword associated with the at least one advertising content from an advertiser; a profile determining module configured to associate the at least one target user group with at least one demographic category of users; an advertisement database configured to store the at least one advertising content in association with the at least one demographic category and the at least one search keyword; a profile obtaining module configured to obtain user profile information associated with a user entering a search keyword; means for retrieving advertising content from the advertisement database corresponding to demographic information contained in the obtained user profile information and the at least one search keyword received from the user; and an information providing module configured to displaying at least a portion of the retrieved advertising content to the user.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 illustrates a network connection of a system for displaying advertising content according to an embodiment of the present invention;

FIG. 2 is a block diagram illustrating a configuration of a system for displaying advertising content according to an embodiment of the present invention;

FIGS. 3 and 4 illustrate an example of an advertisement database according to an embodiment of the present invention;

FIG. 5 illustrates an example of a user profile database according to an embodiment of the present invention;

FIG. 6 illustrates an example of retrieving a keyword according to an embodiment of the present invention; and

FIG. 7 is a flowchart illustrating a method of providing advertising content according to an embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a module. One or more components can reside within a process and/or thread of execution, and a module or component can be localized on one computer and/or distributed between two or more computers.

As used herein, the terms “desktop,” “PC,” “local computer,” and the like, refer to computers on which systems (and methods) according to the invention operate. In the illustrated embodiments, these are personal computers, such as portable computers and desktop computers; however, in other embodiments, they may be other types of computing devices (e.g., workstations, mainframes, personal digital assistants or PDAs, music or MP3 players, and the like).

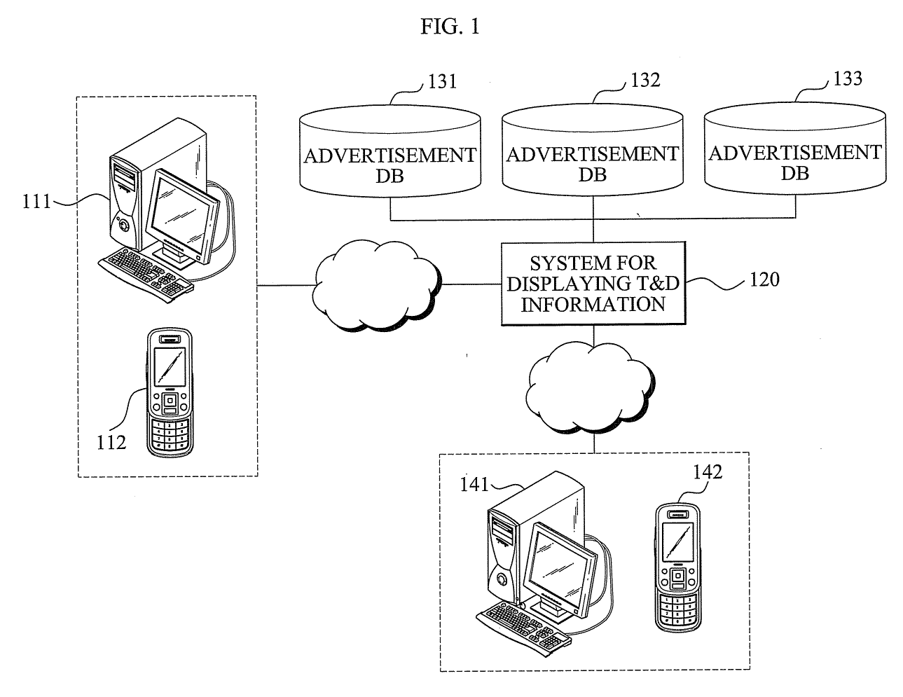

FIG. 1 illustrates a network connection of a system 120 for displaying advertising content according to an embodiment of the present invention.

As shown in FIG. 1, the system 120 receives the advertising contents which include title and description of the advertisement and a search word from advertisers 111 and 112. The advertising content is provided based on an advertisement target to be displayed. The system 120 determines user profile information corresponding to the advertisement target to be displayed, stores the determined user profile information in advertisement databases 131, 132, and 133 in association with the received advertising content and the search word, obtains user profile information associated with users 141 and 142 entering a keyword, and provides corresponding advertising content.

The advertisers 111 and 112 provide advertising content based on an advertisement target to be displayed and a search word associated with the advertising content. The advertising content denotes one advertisement type that consists of a title and a description before click and may be expressed in association with a keyword entered from a user. The search word may include all types of information that the user may enter, such as characters, numerals, a Universal Resource Locator (URL), an Internet Protocol (IP) address, and the like. The advertisers 111 and 112 may provide a plurality of advertising content for a single search word and may also prepare the same advertising content for different search words with the similarity among a plurality of search words. Also, the advertisers 111 and 112 provide a target page corresponding to advertising content and may provide a detailed page of the search word using the target page.

The system 120 receives from the advertisers 111 and 112 the search word and the advertising content that is provided based on the advertisement target to be displayed. The system 120 determines user profile information corresponding to the advertisement target to be displayed. The user profile information denotes information that can be used to easily identify characteristics and preference of the user entering the keyword, for example, a sex, an age, a region of residence, and the like. The system 120 may store the determined user profile information in the advertisement databases 131, 132, and 133 in association with the advertising content and the search word. The advertisement databases 131, 132, and 133 are allocated to the advertisers 111 and 112.

As described above, the advertisement databases 131, 132, and 133 are allocated to each of the advertisers 111 and 112, and stores the search word, user profile information, advertising content, and the target page in association with each of the advertisers 111 and 112. Information stored in the advertisement databases 131, 132, and 133 may be corrected and deleted by the advertisers 111 and 112.

The system 120 receives a keyword from the user and obtains user profile information associated with the user entering the keyword. The system 120 may obtain the user profile information based on any one of login information of the user, IP address information, and cookie information. For this, the system 120 may store the user profile information in a user profile database in association with any one of the login information of the user, the IP address information, and the cookie information. The system 120 identifies from the advertisement databases 131, 132, and 133 the advertising content corresponding to the obtained user profile information and the entered keyword. The system 120 provides the identified advertising content as a search result in response to the keyword. The target page corresponding to the advertising content may be provided.

The users 141 and 142 review the provided search result and the advertising content. The users 141 and 142 may verify the detailed page of the entered keyword by accessing the target page that is provided together with the advertising content.

As described above, according to the present invention, it is possible to provide appropriate advertising content according to user profile information of a user entering a keyword. Accordingly, it is possible to display the advertising content on a target page.

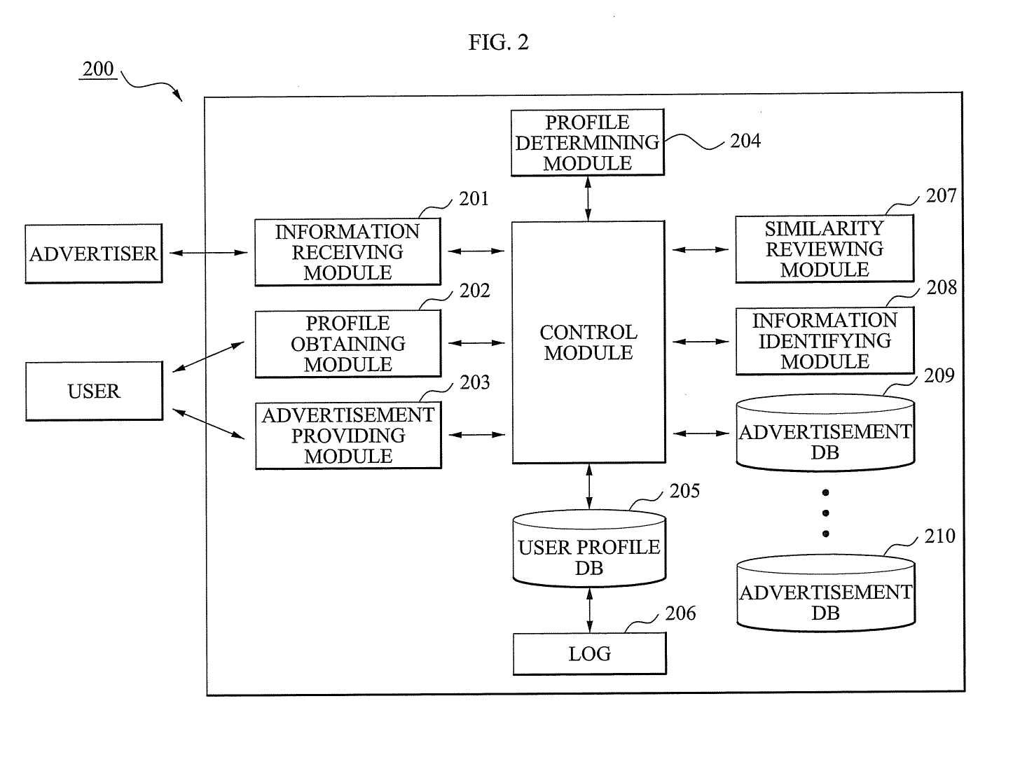

Hereinafter, a configuration of a system 200 for displaying advertising content will be described with reference to FIG. 2.

As shown in FIG. 2, the system 200 includes an information receiving module 201 configured to receive the advertising content and a search word from an advertiser, wherein the advertising content is provided based on an advertisement target to be displayed; a profile determining module 204 configured to determine user profile information corresponding to the advertisement target to be displayed; an advertisement database 209 configured to store the determined user profile information in association with the received advertising content and the search word, wherein the advertisement database 209 is allocated to the advertiser; a profile obtaining module 202 configured to obtain user profile information associated with a user entering a keyword; an information identifying module 208 configured to identify from the advertisement database 209 the advertising content corresponding to the obtained user profile information and the entered keyword; and an information providing module 203 configured to provide the identified advertising content as a search result in response to the keyword. The system 200 further includes a similarity reviewing module 207 configured to review a similarity between a plurality of search words that is received from the advertiser with the advertising content, and a user profile database 205 configured to store the user profile information in association with any one of login information, IP address information, and cookie information.

More specifically, the information receiving module 201 receives from the advertiser the search word and the advertising content that is provided based on the advertisement target to be displayed. The advertisement target to be displayed is a concept of including a user capable of maximizing the advertising effect by providing the advertising content. According to the present invention, it is possible to maximize the advertising effect by providing different advertising content according to the advertisement target to be displayed. The advertising content is one advertisement type that consists of a title and a description before click, and may be expressed in association with the keyword entered from the user. For example, the advertising content may include “GMARKET women's clothing” as the title and includes “blouses, suits, style coordination” as the description. The search word may include all types of information that the user may enter, such as characters, numerals, a URL, an IP address, and the like. For example, the search word such as “fashion, appliances, freezers” and the like may be entered.

The information receiving module 201 may receive from the advertiser a plurality of different advertising content with respect to the search word. For example, with respect to the search word “fashion”, the information receiving module 201 may receive advertising content that includes “GMARKET fashion shopping” as the title and “Hollywood style, New York style, luxury style” as the description, and another advertising content that includes “GMARKET men's clothing” as the title and “hot fashion, men coordination, and clothing sales” as the description. Since the different advertising content are provided for the same search word, it is possible to display various types of advertisements.

The information receiving module 201 receives from the advertiser a target page corresponding to each of the plurality of advertising content. The target page provides a detailed page for the keyword entered from the user to enable the user to directly access the desired page. For example, the advertiser may predict that the user who is a “woman in twenties” enters keyword “fashion” and thus may register a target page of “women's clothing” together with advertising content that includes “GMARKET fashion shopping” as the title and “Hollywood style, New York style, luxury style” as the description. In this case, the user may directly move to a specific page instead of a GMARKET main page or a page of another field such as a page for appliances, men's clothing, or others. Accordingly, it is possible to improve the user satisfaction.

The profile determining module 204 determines user profile information corresponding to the advertisement target to be displayed. The user profile information includes information about a sex, a region, an age, and the like, of each user requesting a keyword search according to a demographic classification category. The demographic classification category denotes demographic features that determine how people of a targeted group such as a certain sex, age, income, marital status, geographical location, and occupation are classified and which group the classified people will belong to. In order to provide a tailored advertisement for the user's characteristics or preferences, the profile determining module 204 needs to determine user profile information with respect to the advertising content that is provided based on the advertisement target to be displayed. Accordingly, the profile determining module 204 may determine user profile information based on whether the advertisement target to be displayed is a woman in twenties, a man in forties, a person living in Busan, or a person living in Seoul.

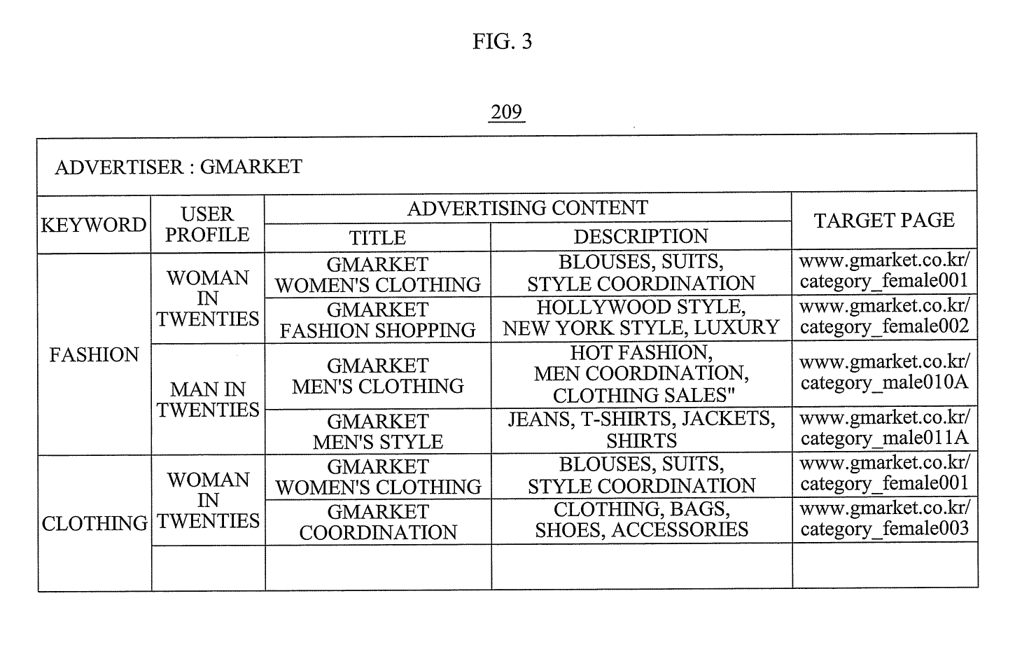

The advertisement database 209 is allocated to the advertiser and stores the determined user profile information in association with the advertising content and the search word. According to an aspect of the present invention, the system 200 may allocate the advertisement database for each advertiser and maintain the allocated advertisement database. As shown in FIG. 2, the system 200 may maintain a plurality of advertisement databases 209 and 210. FIG. 3 shows an example advertisement database 209 when an advertiser is “GMARKET” and an example advertisement database 210 when an advertiser is “WOORI home shopping”.

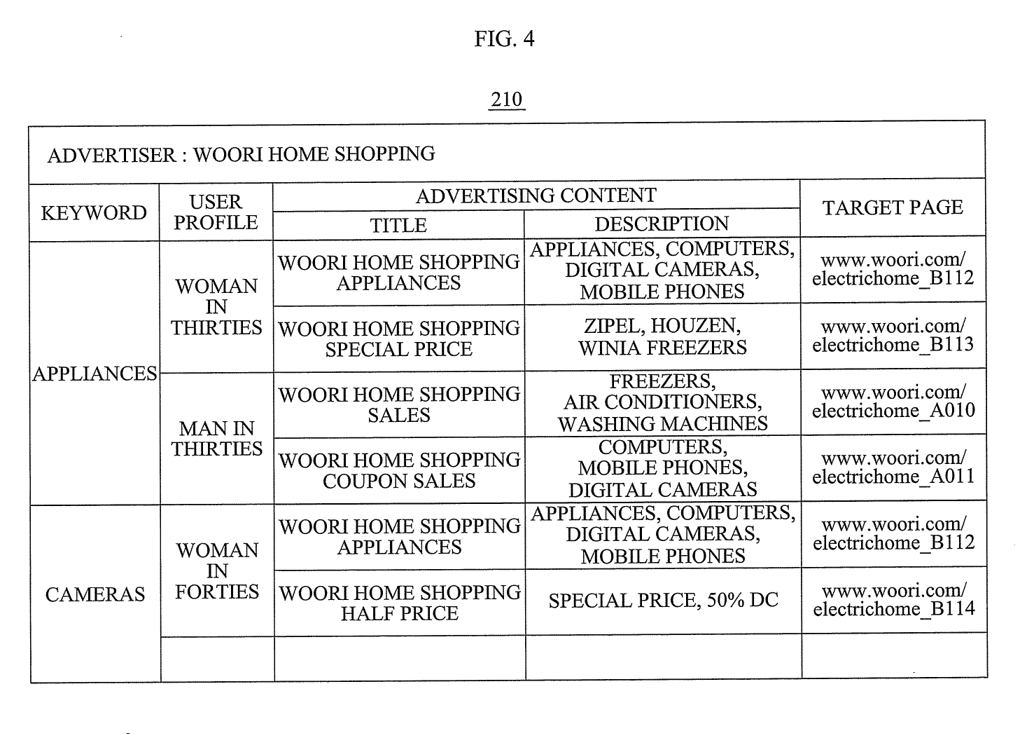

Hereinafter, the advertisement databases 209 and 210 will be described with reference to FIGS. 3 and 4, respectively.

As shown in FIG. 3, with respect to the advertiser “GMARKET”, the advertisement database 209 stores keywords “fashion” and “clothing”, a plurality of advertising content corresponding to user profile information, and a target page. As described above, with respect to a single keyword “fashion”, the advertisement database 209 stores a plurality of advertising content such as “GMARKET women's clothing/blouses, suits” and “GMARKET fashion shopping/Hollywood style, New York Style”, and target pages “www.gmarket.co.kr/category_female001” and “www.gmarket.co.kr/category_female002”. According to an aspect of the present invention, since a different target page is provided for different advertising content, a user, for example, a woman in twenties may directly move to a detailed page for selling the women's clothing. Accordingly, it is possible to improve the user satisfaction.

The advertisement database 209 may store different advertising content according to user profile information. For example, when the user profile is a “woman in twenties”, the advertisement database 209 stores advertising content that includes “GMARKET women's clothing” as the title and “blouses, suits, style coordination” as the description. When the user profile is a “man in twenties”, the advertisement database 209 stores advertising content that includes “GMARKET men's style” as the title and “jeans, T-shirts, jackets, shirts” as the description.

When there is a similarity between different search words, the advertisement database 209 may store the same advertising content. According to an aspect of the present invention, the similarity reviewing module 207 reviews the similarity between a plurality of search words that is received from the advertiser with the advertising content. As shown in FIG. 3, the similarity reviewing module 207 reviews the similarity between the search words “fashion” and “clothing”, and when there is the similarity, stores in the advertisement database 209 the same advertising content that includes “GMARKET women's clothing” as the title and “blouses, suits, style coordination” as the description in association with the search words “fashion” and “clothing”.

As shown in FIG. 4, with respect to the advertiser “WOORI home shopping”, the advertisement database 210 stores keywords “appliances” and “cameras”, a plurality of advertising content, “WOORI home shopping appliances” and “appliances, computers, digital cameras, mobile phones”, corresponding to user profile information that denotes a woman in thirties, and a target page “www.woori.com/electrichome_B112”. With respect to the search words “appliances” and “cameras” of which the similarity is reviewed, the advertisement database 210 stores the same advertising content that includes “WOORI home shopping appliances” as the title and “appliances, computers, digital camera, mobile phones” as the description and the target page “www.woori.com/electrichome_B112”.

The profile obtaining module 202 obtains user profile information associated with the user entering the keyword. For this, the system 200 maintains the user profile database 205 configured to store the user profile information in association with any one of login information, IP address information, and cookie information. The profile obtaining module 202 may obtain from the user profile database 205 the user profile information associated with the user entering the keyword.

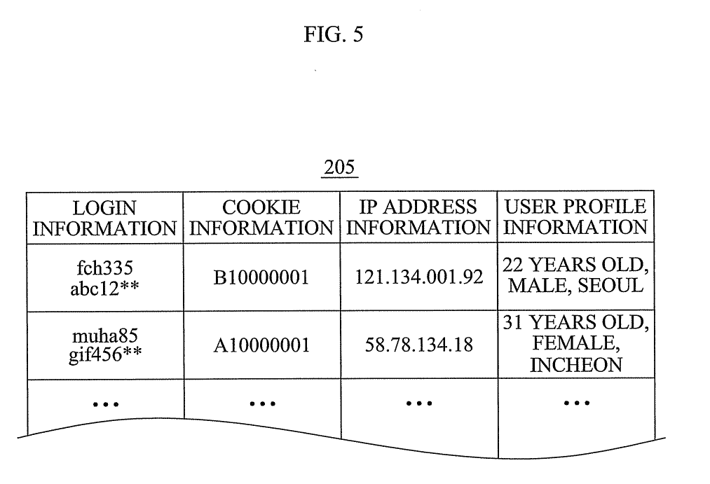

Hereinafter, the user profile database 205 will be described with reference to FIG. 5.

The user profile database 205 stores user profile information in association with any one of login information of each user, IP address information, and cookie information.

According to an aspect of the present invention, the system 200 may provide personal services for each user such as search services, email functions, communities, blogs and the like available in the Internet. In order to provide the personal services, the system 200 should receive a user identification (ID) and a password from the user. In this case, the system 200 may receive user profile information such as an age, an address, a sex, a contact number, and the like. The system 200 may store the received user profile information such as “31 years old, female, Incheon” in the user profile database 205 in association with login information about the user ID and the password. The profile obtaining module 202 may obtain from the user profile database 205 user profile information of the user entering the keyword by referring to login information “muha85” and “gif456**” entered from the user at a random point in time.

According to an aspect of the present invention, when at least one keyword search request is received from the user, the system 200 may store IP address information of the user in a log 206 and store the stored IP address information in the user profile database 205 in association with the user profile information and login information that is entered from the user at a random point in time. The profile obtaining module 202 may obtain the user profile information from the user profile database 205 by referring to the IP address information, for example, “121.134.001.92” and “58.78.134.18”, of the user entering the keyword.

According to an aspect of the present invention, the system 200 may assign cookie information as an identifier for identifying a user accessing the system 200 and store user profile information corresponding to the cookie information in the user profile database 205. A browser cookie denotes a value that is issued to identify the uniqueness of a browser accessing the system 200. Accordingly, the browser cookie is issued to a single browser only once. When the user deletes the previously issued cookie, the browser cookie may be re-issued. In this case, the profile obtaining module 202 may obtain user profile information from the user profile database 205 by referring to cookie information, for example, “B10000001 and A10000001”, of the user entering the keyword.

From characteristics of search service users, the user may not log in. However, when the user logs in at least, once, cookie information or IP address information is stored in the user profile database 205 in association with the user profile information. Accordingly, even when the user does not perform login, it is possible to provide advertising content tailored for the user.

The information identifying module 208 identifies from the advertisement database 209 advertising content corresponding to the entered keyword and the obtained user profile information. The information identifying module 208 may identify from the advertisement database 209 a target page corresponding to the identified advertising content.

The advertisement providing module 203 provides the identified advertising content and the target page as a search result in response to the entered keyword.

As described above, according to an aspect of the present invention, it is possible to obtain the targeting effect of advertising content that is displayed in a target page by providing the advertising content in association with the target page.

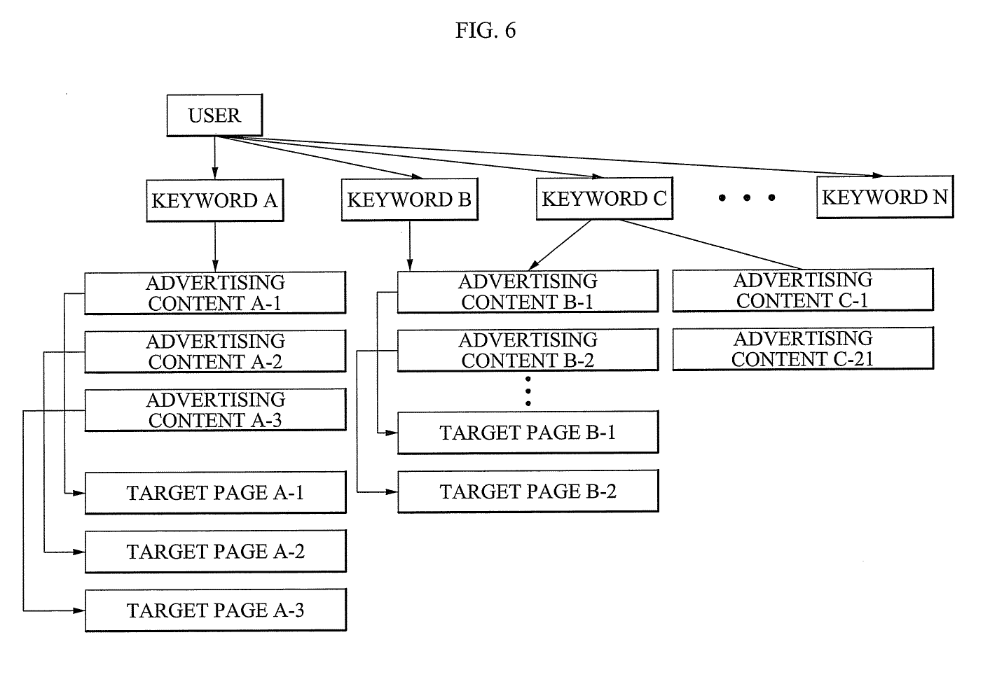

FIG. 6 illustrates an example of retrieving a keyword according to an embodiment of the present invention.

A system for displaying advertising content receives from an advertiser a search word and advertising content that is provided based on an advertisement target to be displayed. The system receives from the advertiser a plurality of advertising content with respect to a single search word, and also receives and stores a target page corresponding to each of the plurality of advertising content. As shown in FIG. 6, the system for displaying advertising content identifies a plurality of advertising content A-1, A-2, and A-3 and a plurality of target pages A-1, A-2, and A-3 with respect to a keyword A entered from a user, and provides the identified advertising content. As described above, according to an aspect of the present invention, it is possible to obtain the targeting effect of advertising content displayed in a target page and also connect a plurality of advertising content to the target page via various types of channels.

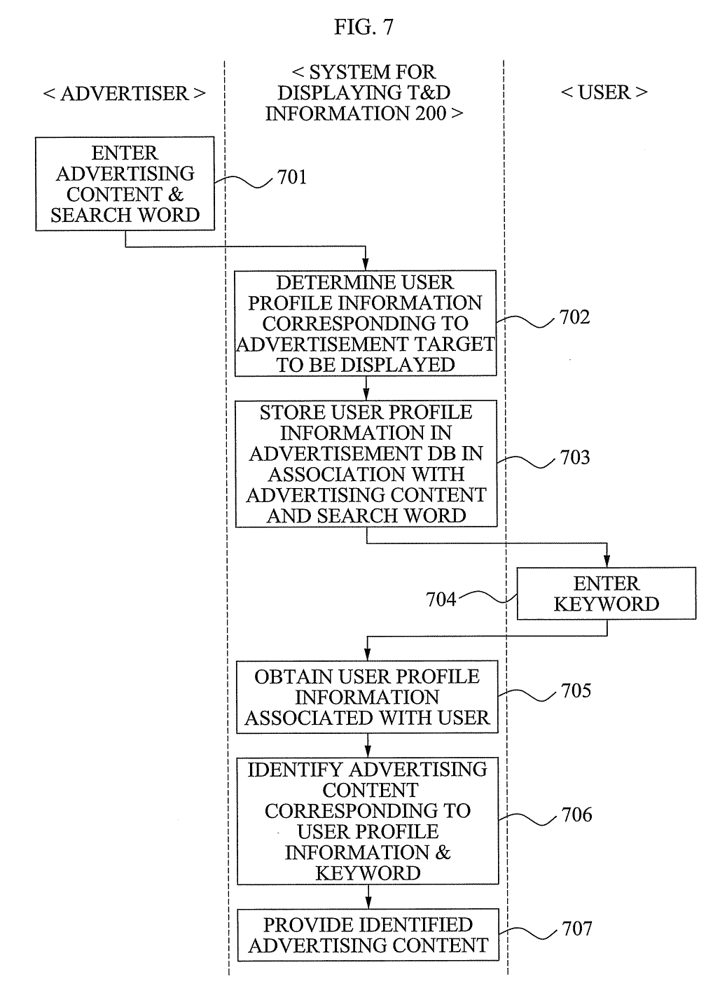

FIG. 7 is a flowchart illustrating a method of providing advertising content according to an embodiment of the present invention. The method of providing advertising content may be performed by the system 200 for displaying advertising content as shown in FIG. 2.

In operation 701, an advertiser enters advertising content and a search word in the system 200. Referring to FIGS. 3 and 4, the advertising content denotes one advertisement type that consists of a title and a description before click and may be expressed in association with a keyword entered from a user. The search word may include all types of information that the user may enter, such as characters, numerals, a URL, an IP address, and the like. The advertiser may enter a target page corresponding to the advertising content. Accordingly, the information receiving module 201 receives the search word, the advertising content, and the target page from the advertiser.

In operation 702, the profile determining module 204 determines user profile information corresponding to the advertisement target to be displayed. The user profile information includes information about a sex, a region, an age, and the like, of each user requesting a keyword search according to a demographic classification category. In order to provide a tailored advertisement for the user's characteristics or preferences, the profile determining module 204 may determine the user profile information with respect to the advertising content that is provided based on advertisement target to be displayed.

In operation 703, the system 200 stores the determined user profile information in the advertisement database 209 in association with the advertising content and the search word. The advertisement database 209 is allocated to the advertiser. As described above with reference to FIG. 3, the advertisement database 209 stores the plurality of advertising content and the plurality of target pages with respect to the single keyword, for example, “fashion”. For example, the advertisement database 209 sets a different target page based on the advertising content and thus enables the user “woman in twenties” to directly move to the detailed page for “selling women's clothing”. Accordingly, it is possible to improve the user satisfaction. According to an aspect of the present invention, the similarity reviewing module 207 reviews the similarity between the plurality of search words that are received from the advertiser together with the advertising content. When there is the similarity between the plurality of different search words, the advertisement database 209 may store the same advertising content.

In operation 704, a user enters a keyword.

In operation 705, the profile obtaining module 202 obtains user profile information associated with the user entering the keyword. Referring to FIG. 5, the system may maintain the user profile database 205 configured to store the user profile information in association with any one of login information, IP address information, and cookie information. The profile obtaining module 202 may obtain from the user profile database 205 user profile information associated with the user entering the keyword.

In operation 706, the information identifying module 208 identifies from the advertisement database 209 advertising content corresponding to the entered keyword and the obtained user profile information. The information identifying module 208 may identify from the advertisement database 209 the target page corresponding to the identified advertising content.

In operation 707, the advertisement providing module 203 provides the identified advertising content as a search result in response to the keyword. The advertisement providing module 203 may provide the identified target page as the search result.

As described above, according to the present invention, it is possible to receive from an advertiser advertising content corresponding to a search word and a target page associated with the search word, and store the received advertising content and the target page in an advertisement database. Accordingly, it is possible to provide the target page corresponding to a search request from a user entering a keyword.

The advertising content providing method according to the above-described exemplary embodiments of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

According to the present invention, there is provided a method and system for providing advertising content that can receive from an advertiser a search word and advertising content that is provided based on an advertisement target to be displayed, store the search word and the advertising content in association with user profile information, and provide appropriate advertising content according to user profile information of a user entering a keyword and thereby can display the advertising content in a target page.

Also, according to the present invention, there is provided a method and system for providing advertising content that can receive a plurality of search words from an advertiser, review a similarity between the plurality of search words, and store different search words with the similarity in an advertisement database in association with the same advertising content, and thereby can provide the same advertising content when a different keyword with the similarity is entered from a user.

Also, according to the present invention, there is provided a method and system for providing advertising content that can receive a target page corresponding to each of a plurality of advertising content and store the received target page in an advertisement database in association with corresponding advertising content and thereby can obtain the targeting effect of the advertising content displayed in the target page.

Also, according to the present invention, there is provided a method and system for providing advertising content that can receive from an advertisement advertising content corresponding to a search word and a target page associated with the search word and store the received advertising content and the target page in an advertisement database and thereby can provide a target page corresponding to a request of a user entering a keyword.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. Section 112, sixth paragraph, unless the element is expressly recited using the phrase “means for” or, in the case of a method claim, the element is recited using the phrase “step for.”

What is claimed is:

1. A method of providing advertising content, the method comprising the steps of:
receiving at least one advertising content associated with at least one target user group, and at least one search keyword associated with the at least one advertising content from an advertiser, each of the at least one advertising content including different content to be displayed for advertisement;
associating the at least one target user group with at least one demographic category of potential users;
associating the at least one advertising content with the at least one demographic category and the at least one search keyword in an advertisement database;
detecting a search request from a user, the search request including at least one search keyword;
obtaining user profile information associated with the user;
retrieving advertising content from the advertisement database associated with the demographic information contained in the obtained user profile information and the at least one search keyword received from the user; and
displaying at least a portion of the retrieved advertising content to the user.

2. The method of claim 1, wherein the advertising content comprises a title and brief description of an advertised web page.

3. The method of claim 1, wherein the step of receiving at least one advertising content and at least one search keyword from an advertiser comprises the steps of:
receiving a plurality of advertising contents associated with the at least one search keyword, each of the plurality of advertising contents contains different content to be displayed for advertisement; and
storing the plurality of advertising contents in the advertisement database in association with the at least one search keyword.

4. The method of claim 1, wherein the step of storing comprises the steps of:
receiving from the advertiser the advertising content and a plurality of search keywords; and
indexing the advertising content based, at least in part, upon similarity of the search keywords.

5. The method of claim 1, wherein the step of storing comprises the steps of:
receiving from the advertiser a link to a web page associated with advertising content; and
storing the advertising content in association with the received link.

6. The method of claim 5, further comprising the steps of:
providing the link to the web page associated with advertising content in response to the search request.

7. The method of claim 1, wherein the step of obtaining comprises the steps of:
storing the user profile information in a user profile database in association with login information; and
detecting login of the user to a web site; and
obtaining from the user profile database the user profile information of the user based on the detected login information.

8. The method of claim 1, further comprising the steps of:
storing Internet Protocol (IP) address information of the user in a log when at least one search request is received from the user; and
storing the IP address information in a user profile database in association with the user profile information and login information,
wherein the step of obtaining comprises the step of:
obtaining the user profile information from the user profile database by referring to the IP address information of the user entering the search keyword.

9. The method of claim 1, wherein the step of obtaining comprises the steps of:
storing the user profile information in a user profile database in association with cookie information;
retrieving the cookie information from a user terminal of the user entering the search keyword; and
obtaining from the user profile database the user profile information corresponding to the retrieved cookie information.

10. One or more computer-readable media having stored thereon a computer program that, when executed by one or more processors, causes the one or more processors to perform acts including:
receiving at least one advertising content associated with at least one target user group, and at least one search keyword associated with the at least one advertising content from an advertiser, each of the at least one advertising content including different content to be displayed for advertisement;
associating the at least one target user group with at least one demographic category of potential users;
associating the at least one advertising content with the at least one demographic category and the at least one search keyword in an advertisement database;
detecting a search request from a user, the search request including at least one search keyword;
obtaining user profile information associated with the user;
retrieving advertising content from the advertisement database associated with the demographic information contained in the obtained user profile information and the at least one search keyword received from the user; and
displaying at least a portion of the retrieved advertising content to the user.

11. A system for providing advertising content, the system comprising:
an information receiving module configured to receive at least one advertising content associated with at least one target user group, and at least one search keyword associated with the at least one advertising content from an advertiser, each of the at least one advertising content including different content to be displayed for advertisement;
a profile determining module configured to associate the at least one target user group with at least one demographic category of potential users;
an advertisement database configured to store the at least one advertising content in association with the at least one demographic category and the at least one search keyword;
a profile obtaining module configured to obtain user profile information associated with a user entering a search keyword;
means for retrieving advertising content from the advertisement database associated with the demographic information contained in the obtained user profile information and the at least one search keyword received from the user; and
an information providing module configured to displaying at least a portion of the retrieved advertising content to the user.

12. The system of claim 11, wherein the information receiving module receives a plurality of advertising contents associated with the at least one search keyword, each of the plurality of advertising contents contains different content to be displayed for advertisement, and the advertisement database stores the plurality of advertising contents in association with the at least one search keyword.

13. The system of claim 11, further comprising:
means for indexing the advertising content based, at least in part, upon similarity of the search keywords.

14. The system of claim 11, wherein the information receiving module receives from the advertiser a link to a web page associated with advertising content, and the advertisement database stores the advertising content in association with the received link.

15. The system of claim 14, wherein the advertisement providing module provides the link to the web page associated with advertising content in response to the search request.

16. The system of claim 11, further comprising:
a user profile database configured to store the user profile information in association with login information,
wherein the profile obtaining module obtains from the user profile database the user profile information of the user entering the search keyword by referring to the login information that is entered from the user at a random point in time.

17. The system of claim 11, further comprising:
a log configured to store IP address information of the user when at least one keyword search request is received from the user; and
a user profile database configured to store the IP address information in association with the user profile information and login information that is entered from the user at a random point in time,
wherein the profile obtaining module obtains the user profile information from the user profile database by referring to the IP address information of the user entering the search keyword.

18. The system of claim 11, further comprising:
a user profile database configured to store the user profile information in association with cookie information,
wherein the profile obtaining module retrieves the cookie information from a user terminal of the user entering the search keyword, and obtains from the user profile database the user profile information corresponding to the retrieved cookie information.
